(19) United States
(12) Patent Application Publication
(10) Pub. No.: US 2021/0207870 A1
(43) Pub. Date: Jul. 8, 2021

(54) ENTRANCE REFRIGERATOR AND CONTROL METHOD THEREOF

(71) Applicant: LG ELECTRONICS INC., Seoul (KR)

(72) Inventors: Minkyu OH, Seoul (KR); Daewoong KIM, Seoul (KR); Boan KWON, Seoul (KR); Won Jin LEE, Seoul (KR); In Sun YEO, Seoul (KR); Ki Yeal SEO, Seoul (KR); Yanghwan NO, Seoul (KR)

(73) Assignee: LG ELECTRONICS INC., Seoul (KR)

(21) Appl. No.: 16/886,264

(22) Filed: May 28, 2020

(30) Foreign Application Priority Data
Jan. 2, 2020 (KR) 10-2020-0000073

(51) Int. Cl. F25D 13/04; F25D 17/06; F25D 23/02; F25D 23/10; F25D 31/00

(52) U.S. Cl. CPC F25D 13/04; F25D 17/065; F25D 17/067; F25B 2321/021; F25D 23/10; F25D 31/005; F25D 23/028

(57) ABSTRACT

An entrance refrigerator includes a heater turned on in a warming mode. In a structure in which a refrigerating cycle including a compressor, an evaporator, and an evaporator fan, as a cold air supply assembly, is provided, the heater may be disposed at a front of the evaporator fan, and in a structure in which a thermoelectric module including a thermoelectric element, a cold sink, and a heat absorption fan is provided, the heater may be disposed at a front of the heat absorption fan.

### CROSS-REFERENCE TO RELATED APPLICATIONS

This application claims the priority benefit of the Korean Patent Application No. 10-2020-0000073 filed in the Republic of Korea on Jan. 2, 2020, which is hereby incorporated by reference as if fully set forth herein.

### BACKGROUND

### Field of the Invention

The present disclosure relates to an entrance refrigerator and a control method thereof.

### Discussion of the Related Art

Recently, delivery services for delivering articles (or goods) to a certain place has been commonplace. In particular, when the article to be delivered is fresh food, the fresh food may be stored and delivered in a refrigerator or in a warmer, the refrigerator or warmer may be provided in a delivery vehicle, in order to prevent the food from being spoiled or cooled.

Food is generally delivered in a packing material to maintain a cooling or warming state. The packing material is formed of environmental pollutants, such as Styrofoam® or an extruded polystyrene foam or other insulating material. There is an increasing need to reduce the environmental pollutants, including socially and economically.

Additionally, if a user is at home at a delivery time, the user may directly receive food from a courier (i.e., a delivery person) face to face, but if the user is not at home, such as when the delivery time is too early or late, it may be difficult for the user to directly receive food from the courier face to face.

Therefore, there is a need for food to be received even if the user does not come into direct contact with a courier and there is a need for food not to be spoiled or to be overly cooled until the food is finally delivered to the user. That is, there is a need to maintain the food in the manner in which it was delivered, including the temperature it was delivered, in order to preserve its freshness or to keep the food at a desired temperature for consumption.

In order to solve these above problems, recently, a product, such as a refrigerator, is installed at an entrance (e.g., front door) of a user's residence or other place, so that the courier may store the delivered food in the refrigerator to keep the food fresh and the user may access the refrigerator at a convenient time to receive the food.

A related art below discloses an entrance refrigerator provided to be mounted on an entrance door or embedded (e.g., provided) in a wall that borders an entrance hallway.

Related art: Korean Utility Model Registration No. 20-0357547, dated Jul. 19, 2004.

However, the entrance refrigerator presented in the related art may operate only in one of a refrigeration mode or freezing mode and cannot selectively switch to a warming mode operation.

### SUMMARY

An aspect of the present disclosure is directed to providing an entrance refrigerator which operates in a warming mode depending on a type of an article (or good) to be stored, as well as in a refrigeration or freezing operation mode, and a control method thereof.

To achieve these and other advantages and in accordance with the purpose of the disclosure, as embodied and broadly described herein, there is provided an entrance refrigerator including a heater turned on in a warming mode.

In a structure in which a refrigerating cycle including a compressor, an evaporator, and an evaporator fan, as a cold air supply module (e.g., assembly, unit), is provided, the heater may be disposed at a front (e.g., in front) of the evaporator fan, and in a structure in which a thermoelectric module including a thermoelectric element, a cold sink, and a heat absorption fan is provided, the heater may be disposed at a front (e.g., in front) of the heat absorption fan.

The entrance refrigerator according to an embodiment of the present disclosure may further include a defrosting heater, and when the warming mode is entered, only the heater may be turned on alone or the heater and the defrosting heater may be simultaneously turned on.

When the warming mode terminates, the heater and the defrosting heater may be simultaneously turned off or the defrosting heater may be first turned off and the heater may then be turned off.

According to the entrance refrigerator including the components as described above and the control method thereof according to an embodiment of the present disclosure, a warming storage function for a delivery article required to be kept warm, as well as a refrigerating or freezing storage function, may be selectively performed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a front perspective view of a house entrance in which an entrance refrigerator according to an embodiment of the present disclosure is installed.

FIG. 2 is a perspective view showing an inside of a (house) entrance taken along line 2-2 of FIG. 1.

FIG. 3 is a front perspective view of an entrance refrigerator of a storage system for a house entrance according to an embodiment of the present disclosure.

FIG. 4 is a front perspective view of an entrance refrigerator in a state in which an inner door and an outer door are removed according to an embodiment of the present disclosure.

FIG. 5 is a rear perspective view of an entrance refrigerator in a state in which an inner door and an outer door are removed according to an embodiment of the present disclosure.

FIG. 6 is an exploded perspective view of an entrance refrigerator according to an embodiment of the present disclosure.

FIG. 7 is a cross-sectional view, taken along line 7-7 of FIG. 4.

FIG. 8 is a longitudinal cross-sectional view, taken along line 8-8 of FIG. 4.

FIG. 9 is a perspective view of a cold air supply module provided in an entrance refrigerator according to an embodiment of the present disclosure.

FIG. 10 is a front perspective view of an inner case of a cabinet of an entrance refrigerator according to an embodiment of the present disclosure.

FIG. 11 is a rear perspective view of the inner case.

FIG. 12 is a rear perspective view of a guide plate of an entrance refrigerator according to an embodiment of the present disclosure.

FIG. 13 is a front perspective view of a housing according to an embodiment of the present disclosure.

FIG. 14 is a view showing air circulation that occurs at a rear of an entrance refrigerator according to an embodiment of the present disclosure.

FIG. 15 is an exploded perspective view of an evaporator fan module equipped with a warming heater according to an embodiment of the present disclosure.

FIG. 16 is a flowchart illustrating a method of implementing a warming mode according to a first embodiment of the present disclosure.

FIG. 17 is a flowchart illustrating a method of implementing a warming mode according to another embodiment of the present disclosure.

FIG. 18 is a flowchart illustrating a method of implementing a warming mode according to a third embodiment of the present disclosure.

### DETAILED DESCRIPTION OF THE DISCLOSURE

Hereinafter, an entrance refrigerator and a control method thereof according to embodiments of the present disclosure will be described in detail with reference to the accompanying drawings.

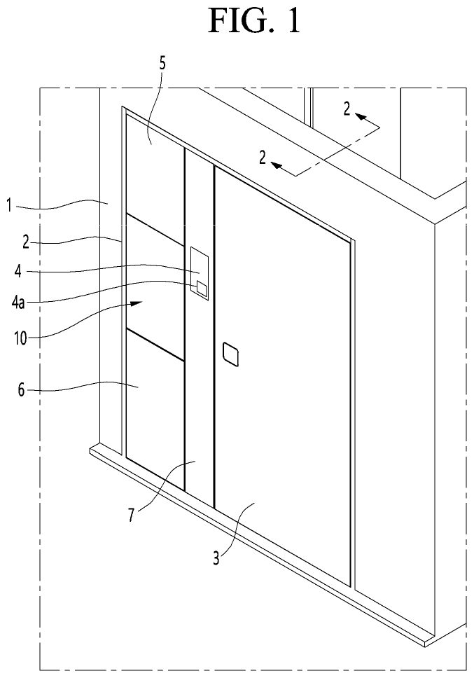

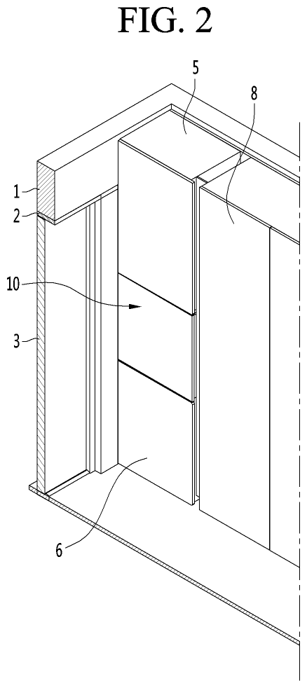

FIG. 1 is a front perspective view of a house entrance in which an entrance refrigerator according to an embodiment of the present disclosure is installed, and FIG. 2 is a perspective view showing an inside of a (house) entrance taken along line 2-2 of FIG. 1.

Referring to FIGS. 1 and 2, an opening is formed on an outer wall 1 partitioning an indoor area and a corridor, and a frame 2 is provided at the edge of the opening. That is, the frame 2 is attached to the opening of the outer wall 1. In addition, an entrance door 3 may be installed inside the frame 2, and an entrance refrigerator 10 may be disposed on a side of the entrance door 3 (e.g., the entrance refrigerator 10 may be positioned within the frame and adjacent to the entrance door 3).

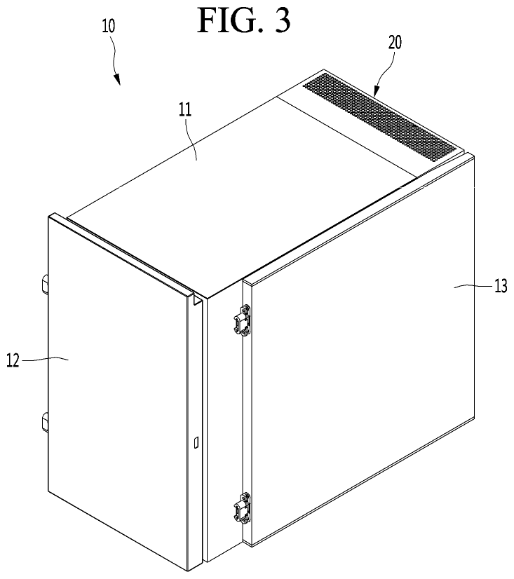

A partition or a partition wall 7 may be formed between the entrance door 3 and the entrance refrigerator 10, and the partition 7 opens and closes the entrance door 3, which may be a front door. The partition 7 may have a control panel 4 for controlling opening and closing of the entrance door 3 and opening and closing of a door 12 (see FIG. 3) of the entrance refrigerator 10.

The control panel 4 may include at least one of a face recognition sensor for recognizing a face of an approaching person, a code reader for recognizing an encryption code of a delivery service article to be stored in the entrance refrigerator 10, a proximity sensor, a controller 4a (e.g., processor, CPU) and a display unit. Further, the at least one face recognition sensor, the code reader, and the proximity sensor of the code reader 4 may be installed at one side or multiple sides of the control panel 4. A face image of an approaching person, recognized by the face recognition sensor, may be displayed on the display unit of the control panel 4.

In addition, a controller 4a of the control panel 4 may perform a function of controlling opening and closing of an outdoor side door and an indoor side door of the entrance refrigerator 10, as well as a function of controlling opening and closing of the entrance door 3, according to a result of the face recognition.

For example, the controller 4a of the control panel 4 may perform a function of opening an outdoor side door of the entrance refrigerator 10 according to a result of recognizing a delivery article and automatically perform a function of locking the outdoor side door when the outdoor side door is recognized to be closed.

In addition, in a state where one of the outdoor side door and an indoor side door of the entrance refrigerator 10 is open, the controller 4a of the control panel 4 may maintain the other in a closed state.

Alternatively, an independent control panel may be provided for performing the functions on the indoor side door of the entrance refrigerator or the outdoor side door of the entrance refrigerator 10 described above with respect to the control panel 4.

Additionally, an upper side (e.g., upper portion) of the entrance refrigerator 10 may be provided with a first storage 5, and a lower side (e.g., lower portion) thereof, below the first storage 5, may be provided with a second storage 6. The first storage 5 may function as a warmer for storing articles in a warmed state. In addition, the second storage 6 may be maintained at room temperature to simply perform a function of storing a deliver)/service article (e.g., an article not needing to be maintained a particular temperature) or may be maintained at a temperature different from an internal temperature of the entrance refrigerator 10. Alternatively, the second storage may be maintained at a temperature lower than room temperature.

The first storage 5 may be maintained at a refrigerating temperature or freezing temperature, and the second storage 6 may be used as a space maintained at room temperature so as to perform only a function of storing a deliver)/service article.

Additionally, one or a plurality of third storages 8 may be installed on an indoor entrance side wall corresponding to a rear of the entrance refrigerator 10. The third storage 8 may be adjacent to the first storage 5 and the second storage 6, including between the first storage 5 and the entrance door 3 and between the second storage 6 and the entrance door 3. The third storage 8 may be used as a space for storing shoes, umbrellas, or laundry.

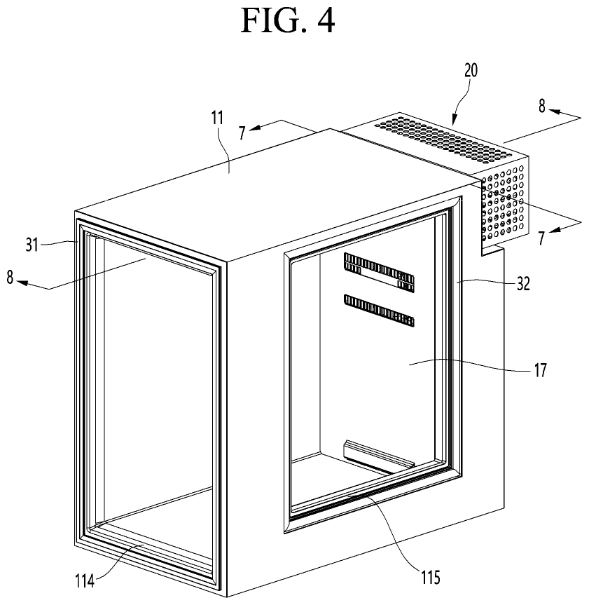

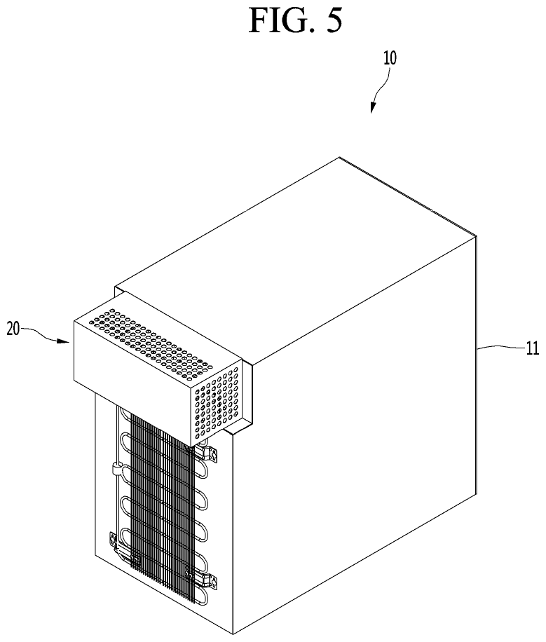

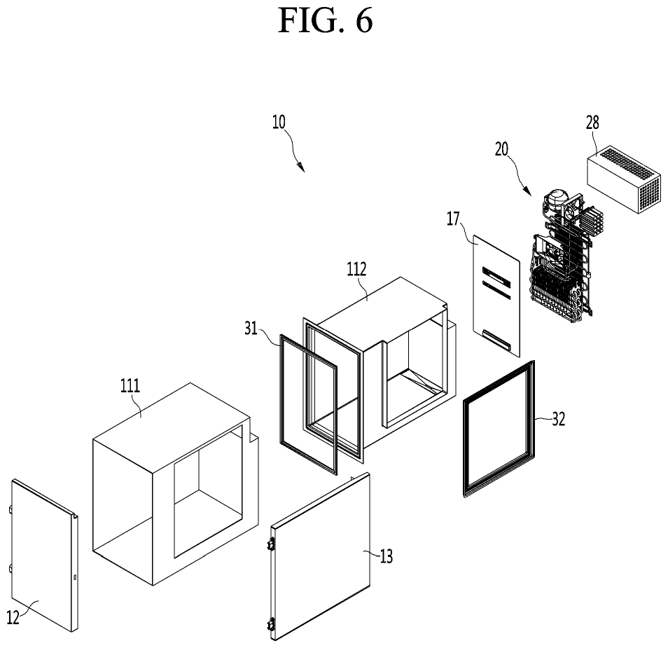

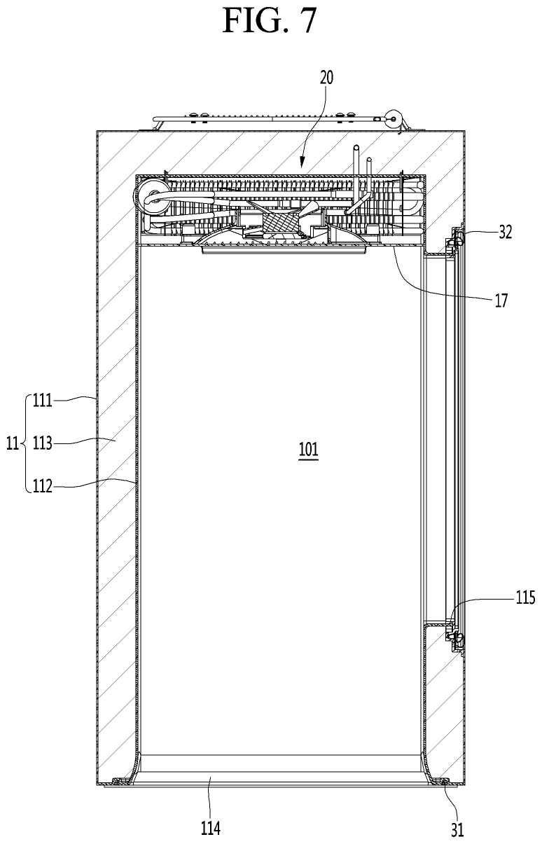

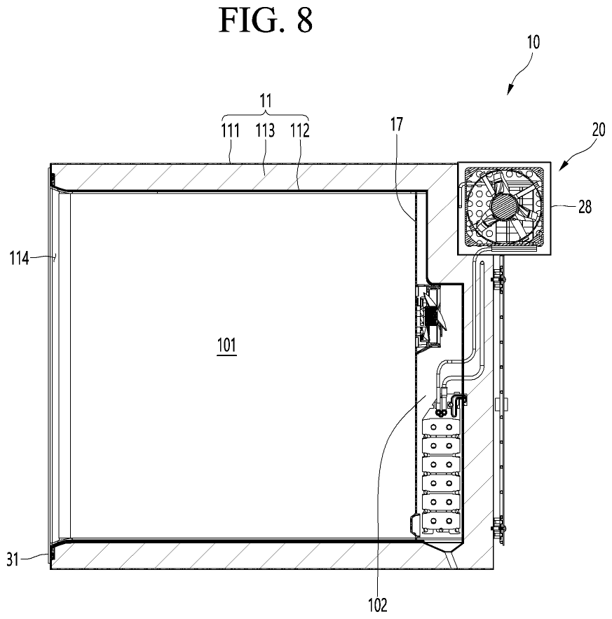

FIG. 3 is a front perspective view of an entrance refrigerator of a storage system for a house entrance according to an embodiment of the present disclosure, FIG. 4 is a front perspective view of an entrance refrigerator in a state in which an inner door and an outer door are removed according to an embodiment of the present disclosure, FIG. 5 is a rear perspective view of an entrance refrigerator in a state in which an inner door and an outer door are removed according to an embodiment of the present disclosure, FIG. 6 is an exploded perspective view of an entrance refrigerator according to an embodiment of the present disclosure, FIG. 7 is a cross-sectional view, taken along line 7-7 of FIG. 4, and FIG. 8 is a longitudinal cross-sectional view, taken along line 8-8 of FIG. 4.

Referring to FIGS. 3 to 8, the entrance refrigerator 10 according to an embodiment of the present disclosure may be understood as a wall-mounted refrigerator in which a front portion penetrates an outer wall 1.

Specifically, the entrance refrigerator 10 may include a cabinet 11 partially embedded in an outer wall 1 (e.g., an entrance/front wall of a dwelling/building), an outer door 12 for opening and closing an outer opening 114 provided at a front end of the cabinet 11, an inner door 13 for opening and closing an inner opening 115 provided on a side surface of the cabinet 11, and one or a plurality of cold air supply modules (e.g., assemblies) 20 mounted on a rear surface of the cabinet 11.

Here, the outer opening 114 may be provided on a front surface of the cabinet 11 and may be defined as a front opening, and the inner opening 115 may be provided on the side surface of the cabinet 11, adjacent to the outer opening 114, and may be defined as a side opening. Alternatively, one of the outer opening 114 and the inner opening 115 may be defined as a first opening and the other may be defined as a second opening. One of the outer door 12 and the inner door 13 may be defined as a first door and the other may be defined as a second door.

In addition, a range in which the entrance refrigerator 10 is mounted on the outer wall 1 partitioning the indoor area and outdoor area may include the entrance refrigerator 10 being attached (e.g., embedded, connected) to a wall that partitions multiple indoor spaces, including a first indoor space and a second indoor space, or a wall that partitions an indoor area and an outer corridor.

For example, the range may also include a case where the entrance refrigerator 10 is attached/embedded in a wall formed between an entrance door and a middle door that separates the entrance and a room of a home, such as a kitchen. In this case, when an article is input in the entrance, the article may be taken out in the kitchen on the other side.

In addition, the entrance refrigerator 10 may further include a cold air supply module 20 mounted on a rear surface of the cabinet 11 and a housing 28 configured to receive (e.g., enclose) some components of the cold air supply module 20. It should be appreciated that the cold air supply module 20 may be defined as including the housing 28.

In addition, the entrance refrigerator 10 may further include an inner gasket 31 and an outer gasket 32 (see FIG. 4). Specifically, the inner gasket 31 is mounted on a front surface of the cabinet 11 corresponding to an edge of the outer opening 114. The outer gasket 32 is mounted on a side surface of the cabinet 11 corresponding to an edge of the inner opening 115.

In addition, the entrance refrigerator 10 may further include a guide plate 17 (e.g., a partition plate) partitioning an internal space of the cabinet 11 into a storage compartment 101 and a cold air generating compartment 102.

Additionally, the cabinet 11 may include an outer case 111 forming an appearance, an inner case 112 provided inside the outer case 111, and a thermal insulator 113 filled between the outer case 111 and the inner case 112. The storage compartment 101 and the cold air generating compartment 102 may be provided inside the inner case 112.

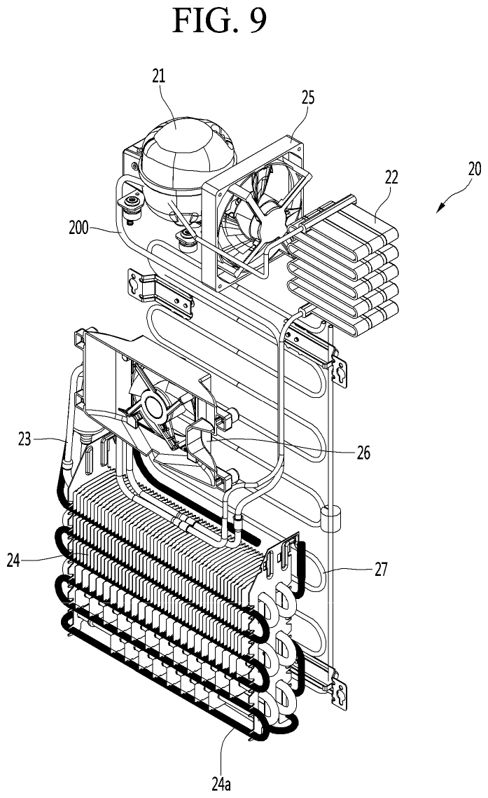

FIG. 9 is a perspective view of a cold air supply module provided in an entrance refrigerator according to an embodiment of the present disclosure.

Referring to FIG. 9, the cold air supply module 20 may include a compressor 21, a condenser 22, 27, a capillary tube 23 (e.g. expansion device), an evaporator 24, a condenser fan 25, an evaporator fan 26, and a refrigerant pipe 200 connecting these components to form a single refrigerant circuit.

In addition, the evaporator 24 may be equipped with a defrost heater 24a, and the defrost heater 24a may operate in a defrost mode for removing frost formed on a surface of the evaporator 24.

The defrost heater 24a may be disposed only at a lower region of the evaporator 24 or may be evenly (e.g., uniformly) installed (e.g., positioned) over front and rear surfaces of the evaporator 24 as illustrated.

Specifically, the condenser may include a main condenser 22 and an auxiliary condenser 27 but it is not excluded that a single condenser is applied according to a design cooling capacity of the entrance refrigerator 10.

The condenser, including the main condenser 22 and/or the auxiliary condenser, may be connected to an outlet side of the compressor 21, and the main condenser 22 and the auxiliary condenser 27 may be connected in series.

Alternatively, the main condenser 22 and the auxiliary condenser 27 may be connected in parallel, and a switching valve may be installed (e.g., positioned) on the refrigerant pipe 200 at a point where the refrigerant pipe is branched toward the main condenser 22 and the auxiliary condenser 27. That is, the switching valve may be positioned on the refrigerant pipe 200 between the main condenser 22 and the auxiliary condenser 27, or any point on the refrigerant pipe 200 to switch between the main condenser 22, the auxiliary condenser 27 and both the main condenser 22 and the auxiliary condenser 27.

According to this structure, only the main condenser 22 may be used or both the main condenser 22 and the auxiliary condenser 27 may be used by adjusting an opening degree of the switching valve depending on required cooling power of the entrance refrigerator 10. Alternatively, both the main condenser 22 and the auxiliary condenser 27 may be used, and here, the amount of a refrigerant moving toward the auxiliary condenser 27 may vary according to an opening degree of the switching valve.

However, it should be appreciated that a structure in which the main condenser 22 and the auxiliary condenser 27 are connected in series may also be implemented.

In addition, the capillary tube 23 is connected to an outlet of the condenser, and the evaporator 24 is connected to an outlet of the capillary tube 23. The refrigerant pipe 200 extending from an outlet of the evaporator 24 is connected to an inlet of the compressor 21.

In addition, the compressor 21, the main condenser 22, and the condenser fan 25 may be accommodated (e.g., positioned) in the housing 28. The condenser fan 25 may be disposed between the compressor 21 and the main condenser 22.

In addition, the auxiliary condenser 27 may be fixed to (e.g., mounted on, positioned on) a rear surface of the cabinet 11, specifically, a rear surface of the outer case 111. When the auxiliary condenser 27 is fixed to the rear surface of the cabinet 11, the auxiliary condenser 27 is exposed to external air.

In addition, the capillary tube 23 is a unit for lowering temperature and pressure by expanding the refrigerant passing through the condenser, and an expansion valve may be utilized instead of the capillary tube 23. The capillary tube 23 may be defined as an example of an expansion member.

The capillary tube 23 and the evaporator 24 may be disposed in the cold air generating compartment 102, and the evaporator fan 26 may be disposed above the evaporator 24 (e.g., spaced apart from the evaporator 24 in a vertical direction).

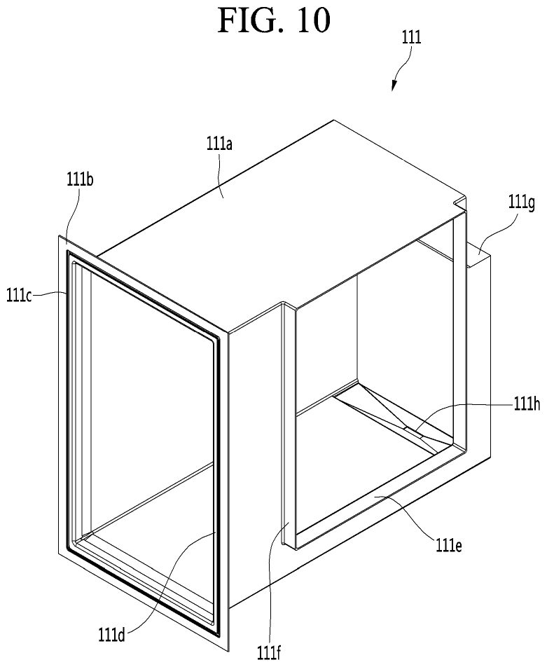

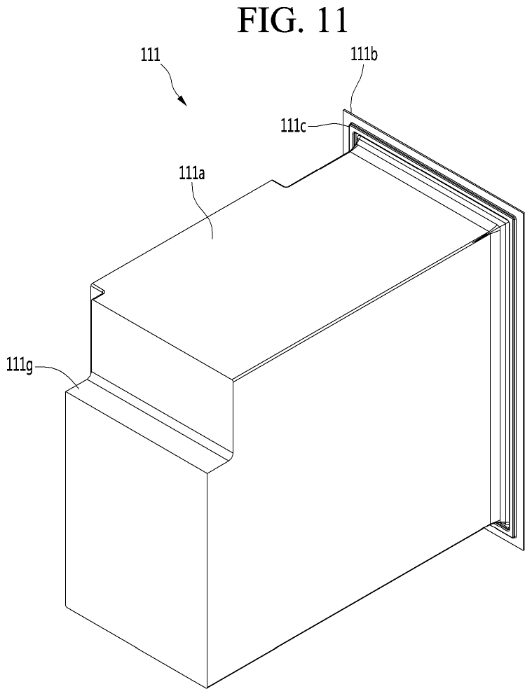

FIG. 10 is a front perspective view of an inner case of a cabinet of an entrance refrigerator according to an embodiment of the present disclosure, and FIG. 11 is a rear perspective view of the inner case.

Referring to FIGS. 10 and 11, the inner case 111 of the cabinet 11 of the entrance refrigerator 10 according to an embodiment of the present disclosure may have a hexahedral shape, or may have any other shape.

The inner case 111 may include a case body 111a in which a front surface and a portion of a side surface are open, a flange 111b extending vertically from a front end of the case body 111a, a sleeve (e.g., flange) 111f protruding by a predetermined length from one side surface of the case body 111a, and a housing seating portion 111g defined on a rear surface of the case body 111a.

An outer opening 111d is formed at an inner edge of the flange 111b, and an inner opening 111e is defined by the sleeve 111f The sleeve 111f protrudes by a predetermined length from the side surface of the case body 111a and is enclosed in a quadrangular band shape to form the inner opening 111e on an inner side thereof. That is, the sleeve 111f may include a left sleeve, a right sleeve, an upper sleeve, and a lower sleeve, and the upper sleeve is coplanar with an upper surface of the case body 111a. The left and right sleeves and the lower sleeve are all perpendicular to the side surface of the case body 111a.

In addition, a gasket groove 111c is recessed on a front surface of the flange 111b, and a fastening portion of the inner gasket 31 is inserted into the gasket groove 111c.

In addition, the flange 111b may be formed by a portion of the case body 111a (e.g., bending a portion of the case body 111a) or the flange 111b may be formed by a separate member (e.g., component, element) that is coupled to the front end of the case body 111a.

In addition, the sleeve 111f may be formed by bending and extending a portion of the side surface of the case body 111a or it should be appreciated that the sleeve 111f may be coupled in a separate flange form to the inner opening 111e.

In addition, a drain hole 111h may be formed on an inner bottom surface of the inner case 111, including an inner bottom surface of the inner case adjacent to a rear surface of the cabinet 11.

Specifically, the inner bottom surface of the inner case 111 may be partitioned into a storage compartment bottom surface and a cold air generating compartment bottom surface by the guide plate 17, and the drain hole 111h may be formed on one side of the cold air generating compartment bottom surface. The drain hole 111h may be formed at the center of the bottom surface of the cold air generating compartment but is not limited thereto.

In addition, as illustrated, the bottom surface of the cold air generating compartment 102 may be designed to be lowered toward the drain hole 111h. That is, the cold air generating compartment 102 may have a bottom surface that is sloped toward the drain hole 111h, such that condensate water or defrost water falling from the evaporator 24 to the bottom surface of the cold air generating compartment flows toward the drain hole 111h.

Additionally, the housing seating portion 111g may be formed on an upper rear side of the inner case 111. Specifically, the housing seating portion 111g may be formed in a shape in which a rear end of the upper surface of the case body 111a is stepped by a predetermined depth. A height of the housing seating portion 111g may be formed to have a length corresponding to a height of the housing 28, and a width of the housing seating portion 111g in a front-rear direction may be designed to be smaller than a width of a bottom portion of the housing 28 in the front-rear direction.

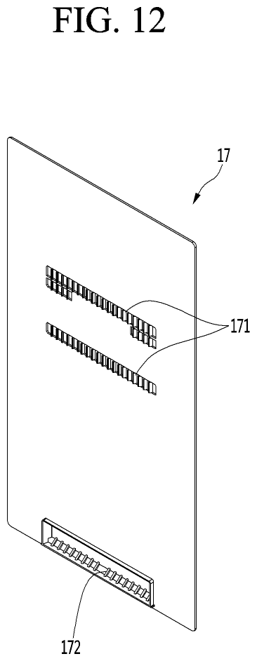

FIG. 12 is a rear perspective view of a guide plate 17 of an entrance refrigerator according to an embodiment of the present disclosure.

Referring to FIG. 12, as described above, the guide plate 17 according to an embodiment of the present disclosure, functions to partition the internal space of the cabinet 11 into a storage compartment 101 and the cold air generating compartment 102. Thus, the guide plate 17 may be defined as a partition plate.

Specifically, a discharge grille 171 may be formed at a point spaced apart by a predetermined distance downward from an upper end of the guide plate 17, and an intake grille 172 may be formed at a lower end of the guide plate 17.

The evaporator fan 26 is coupled to a rear surface of the guide plate 17 corresponding to a position of the discharge grille 171 so that cold air inside the cold air generating compartment 102 may be supplied to the storage compartment 101. That is, the evaporator fan 26 may overlap the discharge grille 171 in a rear direction (e.g., horizontal direction).

In addition, cold air in the storage compartment 101 is returned to the cold air generating compartment 102 through the intake grille 172. Since the discharge grille 171 is formed above the intake grille 172, when the evaporator fan 26 is driven, cold air of the cold air generating compartment 102 is supplied to the storage compartment 101 and then falls to the bottom of the storage compartment. The cold air present on the bottom of the storage compartment 101 is returned to the cold air generating compartment 102 through the intake grille 172. The cold air returned to the cold air generating compartment 102 rises by a pressure difference between an upper space and a lower space of the cold air generating compartment to exchange heat with the evaporator 24.

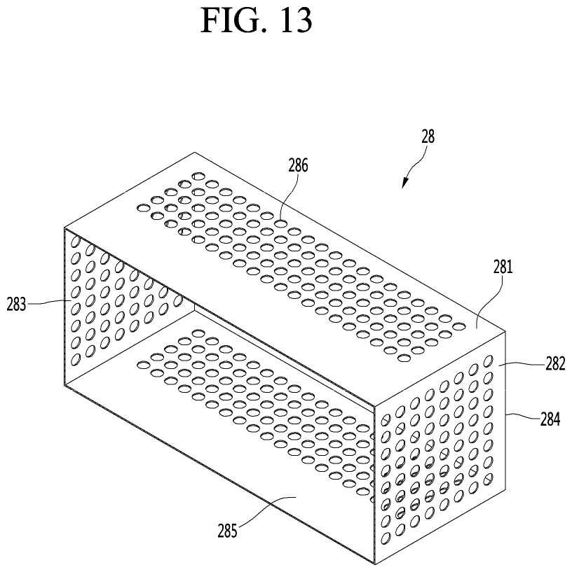

FIG. 13 is a front perspective view of a housing according to an embodiment of the present disclosure.

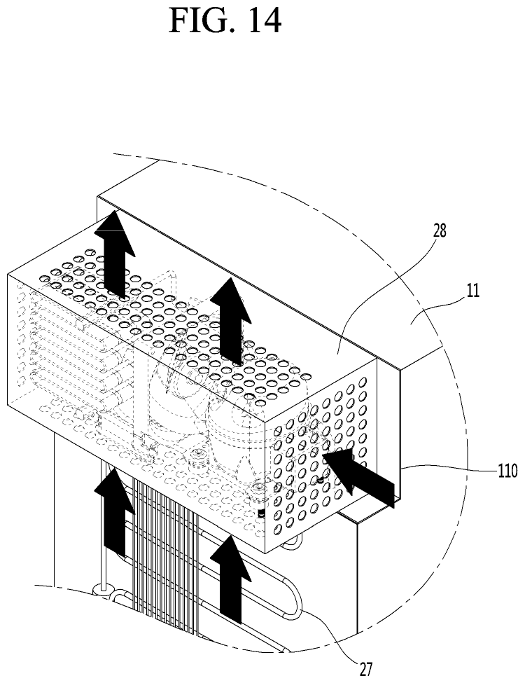

Referring to FIG. 13, the housing 28 according to an embodiment of the present disclosure is placed in the housing seating portion 110 (see FIG. 14) formed on the rear surface of the cabinet 11.

Specifically, the housing seating portion 110 may be formed at a step of the upper end of the rear surface of the cabinet 11, the step extending a predetermined depth. A length of the housing seating portion 110 in the front-rear direction (e.g., horizontal direction) may be smaller than a length of the housing 28 in the front-rear direction, but without being limited thereto, or the length of the housing seating portion 110 in the front-rear direction may be formed to be equal to or greater than the length of the housing 28 in the front-rear direction.

That is, the housing 28 may protrude backward from the rear surface of the cabinet 11 (e.g., the housing 28 may extend past the rear surface of the cabinet 11), so that the rear surface of the housing 28 may be located on a rear side with respect to the rear surface of the cabinet 11.

The housing 28 may be formed in a hexahedral form including a front surface portion, a left surface portion 283, a right surface portion 282, an upper surface portion 281, a rear surface portion 284, and a bottom surface portion 285. Here, the front surface portion may be open or closed. When the front surface portion is open, a front end of the housing 28 may be in close contact with a vertical plane of the housing seating portion 110. Conversely, if the front surface portion is sealed, the front surface portion of the housing 28 may be in close contact with the vertical plane of the housing seating portion 110.

When the length of the housing 28 in the front-rear direction is formed larger than the length of the housing seating portion 110 in the front-rear direction, only a part of the bottom portion 285 is placed on a horizontal portion (or a bottom portion) of the housing seating portion 110.

In addition, a plurality of heat dissipation holes 286 may be formed on each surface of the housing 28 except for the front surface portion and the rear surface portion 284.

Specifically, the plurality of heat dissipation holes 286 may be formed from a point spaced apart by a predetermined distance backward from a front end of the housing 28 on the upper surface portion 281 and the bottom surface portion 285. A region of the bottom surface portion in which the heat dissipation holes 286 are not formed may be a region in which the housing 28 is in close contact with a bottom portion of the housing seating portion 110.

The heat dissipation holes 286 formed in the upper surface portion 281 are also formed from a point spaced apart backward from the front end like the bottom surface portion 285, and thus, there is no need to distinguish between the upper surface portion 281 and the bottom surface portion 285 of the housing 28. If the heat dissipation holes 286 are formed in the entire upper surface portion 281, the bottom surface portion 285 of the housing 28 is designated, and thus, attention may be required in coupling the housing 28 to the housing seating portion 110.

Additionally, the heat dissipation holes 286 may be formed in the entirety of the side surface portions 282 and 283 and the rear surface portion 284.

FIG. 14 is a view showing air circulation that occurs at a rear of an entrance refrigerator according to an embodiment of the present disclosure.

Referring to FIG. 14, the compressor 21 and the condenser, specifically, the main condenser 22, are accommodated in the housing 28, and the auxiliary condenser 27 is mounted on the rear surface of the cabinet 11 to exchange heat with indoor air.

Specifically, when a refrigerating cycle operates, the compressor 21 is driven. The compressor 21 compresses a gaseous refrigerant having a low temperature and low pressure into a gaseous refrigerant having a high temperature and high pressure. Therefore, an internal temperature of the compressor 21 is higher than an external temperature of the housing 28.

In addition, the high-temperature, high-pressure gaseous refrigerant passing through the compressor 21 is changed in phase into a liquid refrigerant having a high temperature and high pressure, while passing through the condensers 22 and 27. In this process, a large amount of heat is released to the outside from the condensers 22 and 27. Efficiency of the refrigerating cycle is increased when air outside the condensers 22 and 27 and the housing 28 are rapidly heat exchanged so that the gaseous refrigerant is entirely changed into the refrigerant in the liquid state.

Therefore, when the condenser fan 25 is driven, the air outside the housing 28 should be introduced into the housing 28, and this is more advantageous as flow resistance is smaller in the inflow process. For this reason, the plurality of heat dissipation holes 286 are formed on the surface of the housing 28.

Specifically, when the condenser fan 25 is driven, the indoor air outside the housing 28 flows into the housing 28 through the bottom surface portion 285 and the right surface portion 284 of the housing 28. The indoor air introduced into the housing 28 cools the compressor 21, while passing over the compressor 21.

A portion of the indoor air which has cooled the compressor 21 is discharged back to the room through the upper surface portion 281 of the housing 28, and the other remaining portion thereof flows toward the main condenser 22 through the condenser fan 25.

The indoor air flowing toward the main condenser 22 cools the main condenser 22, and then is discharged in a state of having an increased temperature to the room through the upper surface portion 281 of the housing 28.

Here, the indoor air may immediately flow toward the main condenser 22 through the bottom surface portion 285 of the housing 28 due to a pressure difference generated inside the housing 28 in which the main condenser 22 is placed.

As air having a lower density by absorbing heat emitted from the main condenser 22 is discharged to the outside of the housing 28, the pressure inside the housing 28 may be lower than a pressure outside the housing. In this situation, indoor air outside the housing 28 may be introduced into the housing 28 through heat dissipation holes 286 formed in the bottom surface portion 285.

Additionally, since the auxiliary condenser 27 is exposed to the indoor air, the auxiliary condenser 27 may always exchange heat with indoor air, regardless of whether the condenser fan 25 is driven. However, when the condenser fan 25 is driven, forced air flow occurs at the rear region of the cabinet 11, increasing the amount of heat exchange between indoor air and the auxiliary condenser 27.

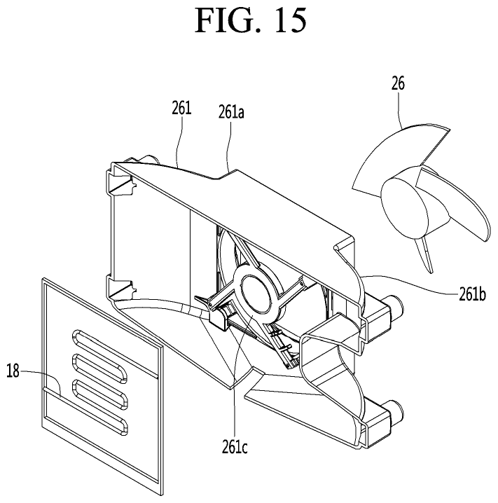

FIG. 15 is an exploded perspective view of an evaporator fan module equipped with a warming heater according to an embodiment of the present disclosure.

Referring to FIG. 15, the entrance refrigerator 10 according to an embodiment of the present disclosure requires a warming heater 18 to implement a warming mode function, and the warning heater 18 may be disposed at a front of the evaporator fan module.

Specifically, the evaporator fan module may include the evaporator fan 26 and a fan cover 261 accommodating the evaporator fan 26.

The fan cover 261 may include a fan accommodating portion 261a accommodating the evaporator fan 26 therein, a cold air diffusing portion 261b extending from a front end of the fan accommodating portion 261a, and a cover grille 261c formed at a front end of the fan accommodating portion 261a.

The cold air diffusing portion 261b may be designed to have a horizontal width or a vertical width increasing toward the front end.

The warming heater 18 may be mounted at a front end region of the fan cover 261. Specifically, the warming heater 18 may be mounted at a certain point between the front end of the cold air diffusing portion 261b and the cover grille 261c.

By this structure, when the evaporator fan 26 operates and power is applied to the warming heater 18, heat generated from the warming heater 18 increases a temperature of air supplied to the storage compartment 101 by the evaporator fan 26.

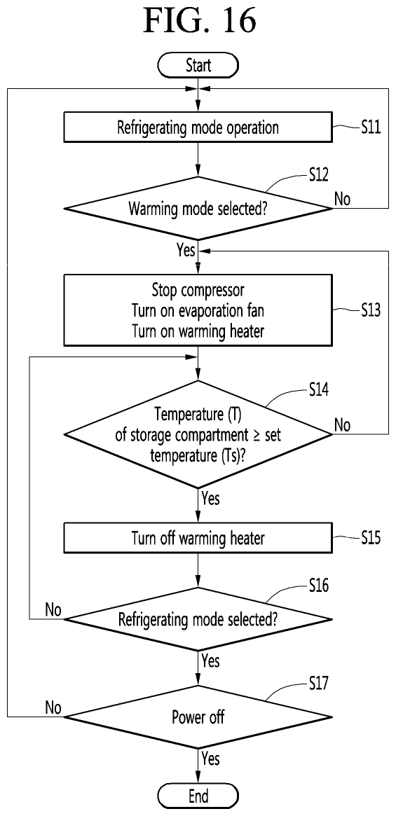

FIG. 16 is a flowchart illustrating a method of implementing a warming mode according to a first embodiment of the present disclosure.

Specifically, while the entrance refrigerator 10 according to an embodiment of the present disclosure operates in a refrigerating mode (S11), the controller 4a of the entrance refrigerator 10 periodically detects whether a warming mode selection command is input through an input unit (input button or a touch button) provided in the control panel (S12).

When the warming mode operation command is input through the input unit, the controller 4a stops driving of the compressor to stop the refrigerating cycle. That is, the controller 4a stops circulation of a refrigerant to stop supply of cold air to the storage compartment 101.

However, the evaporator fan 26 driven in a refrigerating operation (or freezing operation) process is kept in an ON state. Also, the compressor 21 is stopped and the warning heater 18 is turned on. That is, power is applied to the warming heater 18 to allow the warming heater 18 to generate heat (S13).

In the refrigerating mode, cold air in the cold air generating compartment 102 is supplied to the storage compartment 101 through the discharge grille 171 formed in the guide plate 17 according to driving of the evaporator fan 26. The cold air having a relatively increased temperature in the storage compartment 101 is returned to the cold air generating compartment 102 through the intake grille 172 formed at a lower end of the guide plate 17. The cold air returned to the cold air generating compartment 102 is lowered in temperature, while exchanging heat with the evaporator 24, and is again supplied to the storage compartment 101 through the discharge grille 171.

Additionally, when the warming mode starts, since the evaporator fan 26 continues to be driven (e.g., since the evaporator fan 26 remains on), cold air circulating between the cold air generating compartment 102 and the storage compartment 101 remains the same. However, since the driving of the compressor 21 is stopped, circulation of the refrigerant does not occur. As a result, an amount of heat exchange between air in the cold air generating compartment 102 and the evaporator 24 is reduced.

Additionally, when the warming heater 18 is turned on, air rising on the evaporator 24 receives heat from the warming heater 18 to have an increased temperature and is then supplied to the storage compartment 101 through the discharge grille 171.

As such, the temperature of the air supplied to the storage compartment 101 is gradually increased by the heat supplied from the warming heater 18.

The controller 4a periodically receives a storage compartment temperature from a temperature sensor mounted in the storage compartment 101 and determines whether a temperature T of the storage compartment 101 reaches a set temperature Ts (S14). The temperature sensor may be of a type known in the art and may be mounted in the storage compartment 101 by any known means, such as by adhesive bonding, by fastening with a screw, or may include a threaded housing to be threaded into a threaded hole of the storage compartment 101.

If it is determined that the temperature T of the storage temperature has reached the set temperature Ts, the controller 4a turns off the warming heater (S15).

The controller 4a determines whether the refrigerating mode is selected (S16), and while a refrigerating mode entry command is not input, the controller 4a turns off the warming heater 18 so that the temperature T of the storage compartment is maintained at the set temperature Ts.

Additionally, if a command for re-switching to the refrigerating mode is input during the warming mode operation, the controller 4a determines whether a power off signal for turning off power of the entrance refrigerator 10 is input (S17). If no power-off command is input, the process returns to step S11 of operating in the refrigerating mode.

Additionally, in this flowchart, it is described that when the temperature T of the storage temperature reaches the set temperature Ts, the warming heater is turned off and whether to select the refrigerating mode is determined. However, in step S14 of determining the temperature of the storage compartment 101, the controller 4a determines whether the refrigerating mode selection command is input in real time even when the temperature T of the storage compartment 101 does not reach the set temperature Ts. If the refrigerating mode is selected in a state where the temperature T of the storage compartment does not reach the set temperature Ts, the controller 4a turns off the warming heater and drives the compressor so that the refrigerating mode is performed again.

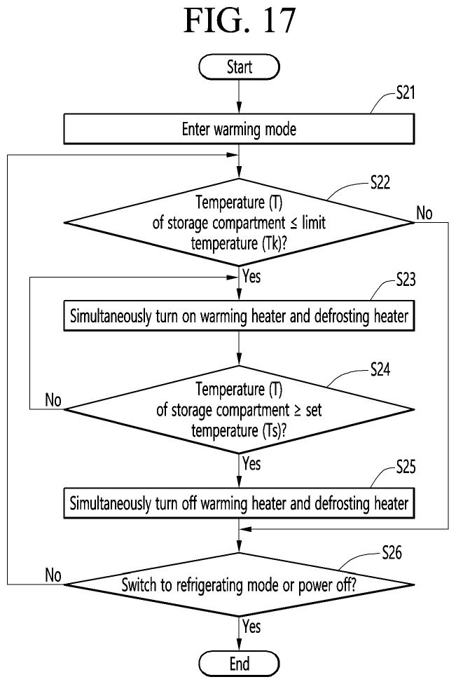

FIG. 17 is a flowchart illustrating a method of implementing a warming mode according to another embodiment of the present disclosure.

Referring to FIG. 17, in a method of controlling an entrance refrigerator for implementing the warming mode according to the present embodiment, the temperature T of the storage compartment is allowed to reach the set temperature Ts by simultaneously turning off the warming heater and the defrosting heater.

Specifically, when a warming mode entry command is input (S21), an operating condition of the entrance refrigerator 10 is switched to the warning mode from a cooling mode or switched to the warming mode from a room temperature storage mode. The room temperature storage mode may be understood as an operation mode in which the refrigerating cycle does not operate.

When the warming mode operation starts according to the warming mode entry command, driving of the compressor is stopped and only the evaporator fan is controlled to be driven as in the former embodiment.

The controller 4a determines whether the current temperature T of the storage compartment falls below a lower limit temperature Tk for warming (S22).

If it is determined that the current temperature T of the storage compartment is higher than the lower limit temperature Tk for warming, the controller 4a periodically determines whether a refrigerating mode switching command or a power-off command is input, while maintaining the OFF state of the warming heater 18.

Additionally, if it is determined that the current temperature T of the storage compartment is lower than the lower limit temperature Tk for warming, the controller 4a turns on the warming heater 18 and the defrosting heater 24a.

Also, the controller 4a receives a temperature value of the storage compartment 101 from the temperature sensor installed/mounted in the storage compartment 101 and determines whether the temperature T of the storage compartment has risen to the set temperature Ts (S24). The set temperature Ts may be defined as an upper limit temperature of the storage compartment.

The warming heater 18 and the defrosting heater 24a are kept in the ON state until the temperature T of the storage compartment reaches the set temperature Ts.

Additionally, if it is determined that the temperature T of the storage compartment has reached the set temperature Ts, the controller 4a simultaneously turns off the warming heater 18 and the defrosting heater 24a (S25).

Then, the controller 4a determines whether a refrigerating mode switching command or the power-off command of the entrance refrigerator is input through the input unit provided in the control panel (S26).

If the refrigerating mode switching command or the power-off command is not input, the controller 4a controls driving of the warning heater 18 and the defrosting heater 24a so that the temperature of the storage compartment is maintained between the lower limit temperature and the upper limit temperature.

According to the present embodiment, when the refrigerating mode is switched to the warming mode, the defrosting heater 24a is operated in a state where circulation of the refrigerant is stopped, thereby advantageously performing a defrosting operation together to remove frost or ice formed on the surface of the evaporator 24.

Here, a heating temperature of the warning heater and a heating temperature of the defrosting heater need to be maintained to be different. Specifically, the heating temperature of the defrosting heater may be kept lower than the heating temperature of the warming heater.

In other words, the defrosting heater is installed in close proximity to the refrigerant pipe of the evaporator 24, and thus, the heating temperature of the defrosting heater is preferably maintained at a temperature lower than the heating temperature of the warming heater 18 in consideration of a possibility of explosion of the refrigerant present in the refrigerant pipe of the evaporator 24.

Therefore, although the temperature T of the storage compartment reaches the set temperature Ts, if the warming heater 18 or the defrosting heater 24a is overheated to a temperature higher than a predetermined heating temperature, the controller 4a may forcibly turn off the overheated heater.

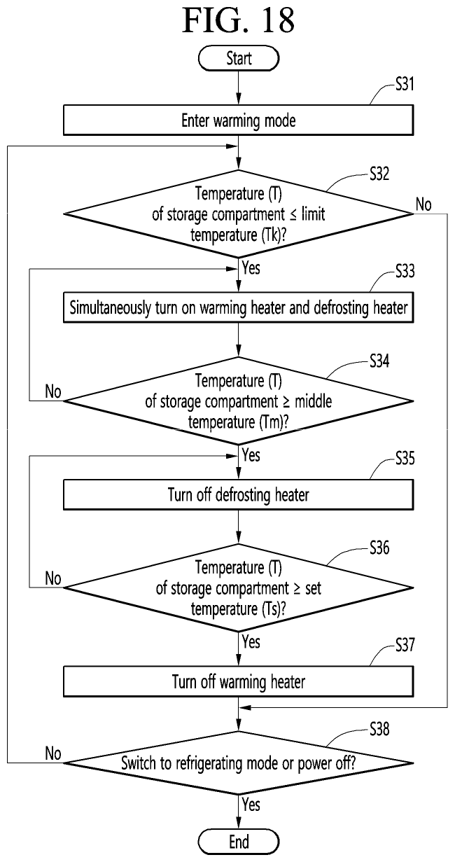

FIG. 18 is a flowchart illustrating a method of implementing a warming mode according to a third embodiment of the present disclosure.

Referring to FIG. 18, in the method of controlling an entrance refrigerator according to the present embodiment, the warming heater and the defrosting heater are simultaneously turned on, the two heaters are turned off with a time difference according to a priority determination. That is, the method of controlling an entrance refrigerator includes prioritizing which of the warming heater and the defrosting heater is first turned off after both are simultaneously turned on.

Specifically, when a warming mode selection command is input and the warming mode is entered (S31), the controller 4a determines whether the temperature T of the storage compartment falls below the lower limit temperature Tk for warming (S32), and if the temperature T of the storage compartment falls below the lower limit temperature Tk for warming, the controller 4a simultaneously turns on the warming heater 18 and the defrosting heater 24a, which is the same as described in the second embodiment.

After the warming heater 18 and the defrosting heater 24a are simultaneously turned on, when the temperature of the storage compartment rises with the lapse of a predetermined time, the controller 4a determines whether the temperature T of the storage compartment reaches a middle temperature Tm (S34). The middle temperature Tm refers to a certain temperature value lower than the set temperature Ts (upper limit temperature for warming) and higher than the lower limit temperature Tk for warming.

For example, the middle temperature Tm may be set to a temperature equal to or higher than a temperature corresponding to a middle point between the upper limit temperature for warming and the lower limit temperature for warming.

If it is determined that the temperature T of the storage compartment has reached the middle temperature, the controller 4a may first turn off the defrosting heater 24a (S35). The reason for this is as follows.

First, when the temperature T of the storage compartment is equal to or higher than the middle temperature, time to reach the set temperature Ts is not long, and thus, it is sufficient to operate only the warming heater 18.

Second, the defrosting heater 24a is turned off relatively early, so that the temperature of the defrosting heater 24a is cooled as close as possible to an external temperature (room temperature) of the entrance refrigerator 10. That is, it is to minimize a phenomenon in which residual heat of the defrosting heater 24a increases a surface temperature of the evaporator to degrade heat exchange efficiency of the evaporator when the operating condition is switched from the warming mode to the refrigerating mode.

Additionally, after the defrosting heater is turned off, the controller 4a continues to determine whether the temperature T of the storage compartment has reached the set temperature Ts (S36), and if it is determined that the temperature T of the storage compartment has reached the set temperature Ts, the controller 4a turns off even the warming heater 18 (S37).

Then, the controller 4a periodically determines whether the refrigerating mode switching command or the power-off command of the entrance refrigerator is input from the input unit (S38). In addition, the controller 4a performs the process of step S32 and the following steps repeatedly while the refrigerating mode switching command or the power-off command is not input.

According to the control method as described above, by allowing the defrosting heater to function as an auxiliary heater, a possibility that the defrosting heater degrades heat exchange performance of the evaporator when the warming mode is switched to the cooling mode may be minimized.

Additionally, the refrigerating cycle including the compressor and the heat exchanger has been presented as an example of a cold air supply module, but a thermoelectric module including a thermoelectric element may also be applied.

When the thermoelectric module is applied, the cold sink attached to the endothermic surface of the thermoelectric element and the heat absorption fan disposed at the front of the cold sink replaces the function of the evaporator and the evaporator fan, and the heat sink attached to the exothermic surface of the thermoelectric element and the heat dissipation fan disposed at the rear of the heat sink replace the function of the condenser fan of the condenser.

Here, the warning heater may be disposed at the front of the heat absorption fan, and the defrosting heater may be disposed on the surface of the cold sink or at a lower region of the cold sink. The control method for implementing the warming mode is the same as the contents described above with reference to FIGS. 16 to 18. However, the action of stopping driving of the compressor may be replaced with the action of stopping application of power to the thermoelectric element.

The evaporator and the evaporator fan or the cold sink and the heat absorption fan may be defined as a heat absorption part, and the condenser and the condenser fan or the heat sink and the heat dissipation fan may be defined as a heat dissipation part. Therefore, the cold air supply module provided in the entrance refrigerator according to the embodiment of the present disclosure may be understood as including the heat absorption part and the heat dissipation part.

Additionally, in the present disclosure, turning on the heater should be interpreted to mean turning on the heater and tuning off the heater should be interpreted to mean tuning off the heater.

It will be apparent to those skilled in the art that various modifications and variations may be made in the present disclosure without departing from the spirit or scope of the disclosures. Thus, it is intended that the present disclosure covers the modifications and variations of this disclosure provided they come within the scope of the appended claims and their equivalents.

What is claimed is:

1. An entrance refrigerator, comprising:
a cabinet, including:
a first surface having a first opening exposed to a first space;
a second surface having a second opening exposed to a second space; and
a storage space,
wherein the cabinet is configured to be embedded in an outer wall partitioning the first space and the second space;
a partition plate partitioning the storage space into a storage compartment at a front of the storage space and a cold air generating compartment at a rear of the storage space;
a first door configured to selectively open and close the first opening;
a second door configured to selectively open and close the second opening;
a cold air supply assembly configured to supply cold air to the storage space, the cold air supply assembling including:
a heat absorption part positioned at the cold air generating compartment and configured to absorb heat from the storage compartment; and
a heat dissipation part positioned outside the cabinet to dissipate the heat transferred from the heat absorption part; and
a first heater mounted in the cold air generating compartment adjacent to the heat absorption part.

2. The entrance refrigerator of claim 1, wherein the heat absorption part includes:
an evaporator configured to evaporate a refrigerant by absorbing heat from cold air of the storage compartment; and
an evaporator fan disposed adjacent to the evaporator.

3. The entrance refrigerator of claim 2, wherein the heat dissipation part includes:
a main condenser configured to condense the refrigerant by dissipating heat to outside of the cabinet; and
a condenser fan disposed adjacent to the main condenser.

4. The entrance refrigerator of claim 3, wherein the cold air supply assembly further includes a compressor configured to compress the refrigerant introduced from the evaporator and discharge the compressed refrigerant to the condenser.

5. The entrance refrigerator of claim 3, wherein the main condenser is connected to the compressor at an outlet side of the compressor.

6. The entrance refrigerator of claim 1, further comprising:
a second heater configured to remove frost from the heat absorption part; and
a controller configured to control the first heater and the second heater.

7. The entrance refrigerator of claim 6, wherein the controller is configured to turn on the first heater in a warming mode.

8. The entrance refrigerator of claim 6, wherein the controller is configured to turn on the first heater and the second heater in a warming mode.

9. The entrance refrigerator of claim 8, wherein the controller is configured to simultaneously turn off the first heater and the second heater when the warming mode terminates.

10. The entrance refrigerator of claim 8, wherein the controller is configured to turn off the second heater and then turn off the first heater when the warming mode terminates.

11. A method of controlling an entrance refrigerator, the entrance refrigerator including:
a cabinet embedded in an outer wall partitioning a first space and a second space, the cabinet including:
a first surface having a first opening exposed to the first space;
a second surface having a second opening exposed to the second space; and
a storage space,
a partition plate partitioning the storage space into a storage compartment at a front of the storage space and a cold air generating compartment at a rear of the storage space;
a first door configured to selectively open and close the first opening;
a second door configured to selectively open and close the second opening;
a cold air supply assembly configured to supply cold air to the storage space, the cold air supply assembling including:
a heat absorption part positioned at the cold air generating compartment and configured to absorb heat from the storage compartment; and
a heat dissipation part positioned outside the cabinet to dissipate the heat transferred from the heat absorption part;
a first heater mounted in the cold air generating compartment adjacent to the heat absorption part;
a second heater mounted on the heat absorption part and configured to remove frost or ice formed on the heat absorption part;
a temperature sensor configured to detect an internal temperature of the storage compartment; and
a controller configured to control operation of the cold air supply assembly, the first heater and the second heater, the method comprising:
stopping, by the controller, an operation of the cold air supply module and starting a warming mode;
turning on, by the controller, the first heater; and
turning off, by the controller, the first heater when a temperature of the storage compartment detected from the temperature sensor reaches a preset temperature.

12. The method of claim 11, wherein the cold air supply assembly further includes a compressor,
wherein the heat absorption part includes:
an evaporator; and
an evaporator fan, and
wherein the method further comprises stopping, by the controller, driving of the compressor and maintaining, by the controller, the evaporator fan in an ON state in the warming mode.

13. The method of claim 12, wherein the heat dissipation part includes:
a condenser connected to the compressor at an outlet side of the compressor; and
a condenser fan disposed adjacent to the condenser, and
wherein the method further comprises:
compressing, by the compressor, a refrigerant; and
condensing, by the condenser, the compressed refrigerant by dissipating heat from the refrigerant to outside of the cabinet.

14. The method of claim 11, further comprising simultaneously turning on, by the controller, the first heater and the second heater in the warming mode.

15. The method of claim 14, further comprising turning on, by the controller, the first heater and the second heater when the temperature of the storage compartment drops to below a lower limit temperature of warming.

16. The method of claim 15, further comprising simultaneously turning off, by the controller, the first heater and the second heater when the temperature of the storage compartment reaches a preset temperature,
wherein the preset temperature is higher than the lower limit temperature of warming.

17. The method of claim 15, further comprising turning off, by the controller, the second heater when the temperature of the storage compartment reaches a middle temperature lower than the preset temperature and higher than the lower limit temperature of warming.

18. The method of claim 17, further comprising turning off, by the controller, the first heater when the temperature of the storage compartment reaches the preset temperature.

19. The method of claim 14, further comprising setting, by the controller, a heating control temperature of the first heater to be higher than a heating control temperature of the second heater.

20. The method of claim 19, further comprising turning off the first heater, by the controller, when a temperature of the first heater exceeds the heating control temperature of the first heater in a state in which the temperature of the storage compartment is lower than the preset temperature.
